(19) United States
(12) Patent Application Publication
(10) Pub. No.: US 2006/0120074 A1
(43) Pub. Date: Jun. 8, 2006

(54) Lamp, backlight assembly and liquid crystal display apparatus having the same

(76) Inventor: Yong-Il Kim, Gyeonggi-do (KR)

Correspondence Address: CANTOR COLBURN, LLP, 55 GRIFFIN ROAD SOUTH, BLOOMFIELD, CT, 06002, US

(21) Appl. No.: 10/538,684

(22) PCT Filed: Dec. 11, 2003
(86) PCT No.: PCT/KR03/02707

§ 371 Date: Jun. 10, 2005

(30) Foreign Application Priority Data
Dec. 12, 2002 (KR) 1020020079143

(51) Int. Cl. F21S 4/00

(52) U.S. Cl. 362/225; 362/29

(57) ABSTRACT

In a lamp capable of improving luminance and uniformity of the luminance, a backlight assembly and an LCD apparatus having the same, the lamp generating a light for displaying an image has a tubular shape. A cross-section of the lamp has a major axis substantially parallel with the light incident surface and a minor axis. Therefore, the lamp supplies the light capable of improving luminance and uniformity of the luminance to decrease power consumption, and volume of the backlight assembly and the LCD apparatus are decreased.

### TECHNICAL FIELD

The present invention relates to a lamp, a backlight assembly and a liquid crystal display (hereinafter, referred to as LCD) apparatus having the lamp. More particularly, the present invention relates to a lamp capable of improving luminance and having enhanced uniformity of the luminance, a backlight assembly and an LCD apparatus having the lamp.

### BACKGROUND ART

An LCD apparatus, in general, is a flat display apparatus displaying an image, a character, moving images, etc. The LCD apparatus includes a liquid crystal control apparatus and an optical apparatus so as to display the image, character, moving images, etc.

The liquid crystal control apparatus includes an LCD panel that controls liquid crystals in a plurality of small liquid crystal units. The optical apparatus includes a lamp and an optical member so as to supply a light having high and uniform luminance to the liquid crystal control apparatus.

The luminance and the uniformity of the luminance are two of the factors that determine display quality of the LCD apparatus. The LCD apparatus having higher luminance and enhanced uniformity of luminance displays a high quality image.

Number of lamps generating a light may be increased, or current provided to the lamps may be increased so as to enhance the luminance of the LCD apparatus.

However, when the number of the lamps is increased, uniformity of luminance of the LCD apparatus may be reduced, and a bright line may also be generated to decrease the display quality of the LCD apparatus.

### DISCLOSURE OF THE INVENTION

The present invention provides a lamp capable of improving luminance and uniformity of the luminance.

The present invention also provides a backlight assembly having a plurality of the lamps supplying a light that is substantially identical to a surface light.

The present invention, in addition, provides an LCD apparatus for displaying an image, a character, a moving picture etc., which has the lamps capable of improving luminance and uniformity of the luminance.

The lamp in accordance with one exemplary embodiment of the present invention includes a lamp body and a plurality of electrodes. The lamp body has a tubular shape. A cross-section of the lamp body has major and minor axes. The major axis of the lamp body is substantially parallel with the light incident surface. The electrodes are disposed on the lamp body to generate a discharge in the lamp body.

The backlight assembly in accordance with one exemplary embodiment of the present invention includes a receiving container, a lamp body, a lamp, a first conducting part and a second conducting part. The receiving container has a bottom plate and a plurality of sidewalls protruded from a side of the bottom plate to define a receiving space. The lamp body has a tubular shape. A cross-section of the lamp body has major and minor axes. The major axis of the lamp body is substantially parallel with the light incident surface. The lamp having first and second electrodes is disposed on the lamp body. The first and second conducting parts apply first and second discharge voltages to the first and second electrodes through a first and second paths, respectively.

The LCD apparatus in accordance with one exemplary embodiment of the present invention includes a receiving container, a lamp body, a lamp, a first conducting part, a second conducting part, a receiving block, optical sheets, an LCD panel and a chassis. The receiving container has a bottom plate and a plurality of sidewalls protruded from a side of the bottom plate to define a receiving space. The lamp body has a tubular shape. A cross-section of the lamp body has a major axis and a minor axis. The major axis of the lamp body is substantially parallel with the light incident surface. The lamp having first and second electrodes is disposed in the lamp body. The first and second conducting parts apply first and second discharge voltages to the first and second electrodes through first and second paths, respectively. The receiving block is formed along an inner surface of a sidewall of the receiving container. The optical sheets are disposed on the receiving block. The LCD panel is disposed on the optical sheets by means of the receiving block. The chassis is secured in the receiving container to prevent the LCD panel from drifting.

Therefore, the lamp doesn't have a circular cylindrical shape, but instead has the tubular shape. The cross-section of the lamp body has major and minor axes, thereby improving luminance and uniformity of luminance.

### BRIEF DESCRIPTION OF THE DRAWINGS

The above and other advantages of the present invention will become readily apparent by reference to the following detailed description when considered in conjunction with the accompanying drawings wherein:

FIG. 1 is a schematic cross-sectional view illustrating a lamp according to an exemplary embodiment of the present invention;

FIG. 2 is a partially cut out perspective view illustrating a lamp according to a first exemplary embodiment of the present invention;

FIG. 3 is a partially cut out perspective view illustrating a lamp according to a second exemplary embodiment of the present invention;

FIG. 4 is a partially cut out perspective view illustrating a lamp according to a third exemplary embodiment of the present invention;

FIG. 5 is a perspective view illustrating a lamp according to a fourth exemplary embodiment of the present invention;

FIG. 6 is a partially cut out perspective view illustrating a lamp according to a fifth exemplary embodiment of the present invention;

FIG. 7 is a partially cut out perspective view illustrating a lamp according to a sixth exemplary embodiment of the present invention;

FIG. 8 is a schematic view illustrating a backlight assembly according to an exemplary embodiment of the present invention;

FIG. 9 is an exploded perspective view illustrating a backlight assembly according to a first exemplary embodiment of the present invention;

FIG. 10 is a cross-sectional view taken along a line A-A′ of FIG. 8;

FIG. 11 is a side view illustrating a lamp supporting member according to the first exemplary embodiment of the present invention;

FIG. 12 is an enlarged perspective view illustrating a portion “B” of FIG. 9;

FIG. 13 is an exploded perspective view illustrating a lamp inserted into a receiving block according to an exemplary embodiment of the present invention;

FIG. 14 is a cross-sectional view taken along a line B-B′ of FIG. 9;

FIG. 15 is a cross-sectional view illustrating first and second conducting parts inserted into first and second slots according to a first exemplary embodiment of the present invention, respectively;

FIG. 16 is a plan view illustrating a backlight assembly according to a second exemplary embodiment of the present invention;

FIG. 17 is an exploded perspective view taken along the backlight assembly of FIG. 16;

FIG. 18 is an exploded perspective view illustrating a backlight assembly according to a third exemplary embodiment of the present invention; and

FIG. 19 is an exploded perspective view illustrating an LCD apparatus according to an exemplary embodiment of the present invention.

### BEST MODE FOR CARRYING OUT THE INVENTION

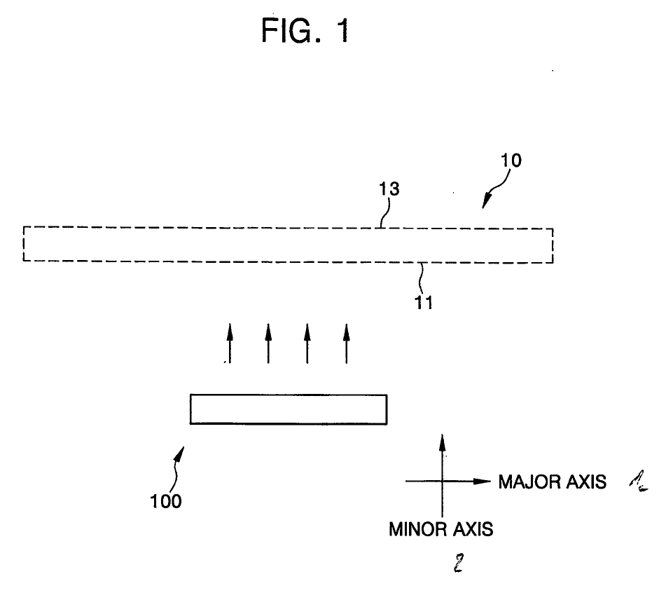

FIG. 1 is a schematic cross-sectional view illustrating a lamp according to an exemplary embodiment of the present invention.

Referring to FIG. 1, an LCD panel 10 displays an image, a character and a moving image. A light generated from a lamp 100 enters the LCD panel 10 through a light incident surface 11 to form an image light. The image light exits the LCD panel 10 through a light exiting surface 13.

The lamp 100 facing the LCD panel 10 has a tubular shape of which cross-section has major and minor axes. That is, the cross-section of the lamp may have an elliptical shape, a rectangular shape, a rectangular shape of which one side is convex, etc.

The major axis of the lamp 100 is substantially parallel with the light incident surface 11 to increase amount of the light incident into the light incident surface 11.

When the light generated from the lamp 10 is substantially perpendicular to the light incident surface 11 of the LCD panel 10, the amount of the light incident into the light incident surface 11 is increased. Preferably, the lamp 100 has a rectangular tubular shape so as to increase the amount of the light incident into the light incident surface 11.

### EMBODIMENTS OF LAMPS

### Embodiment 1

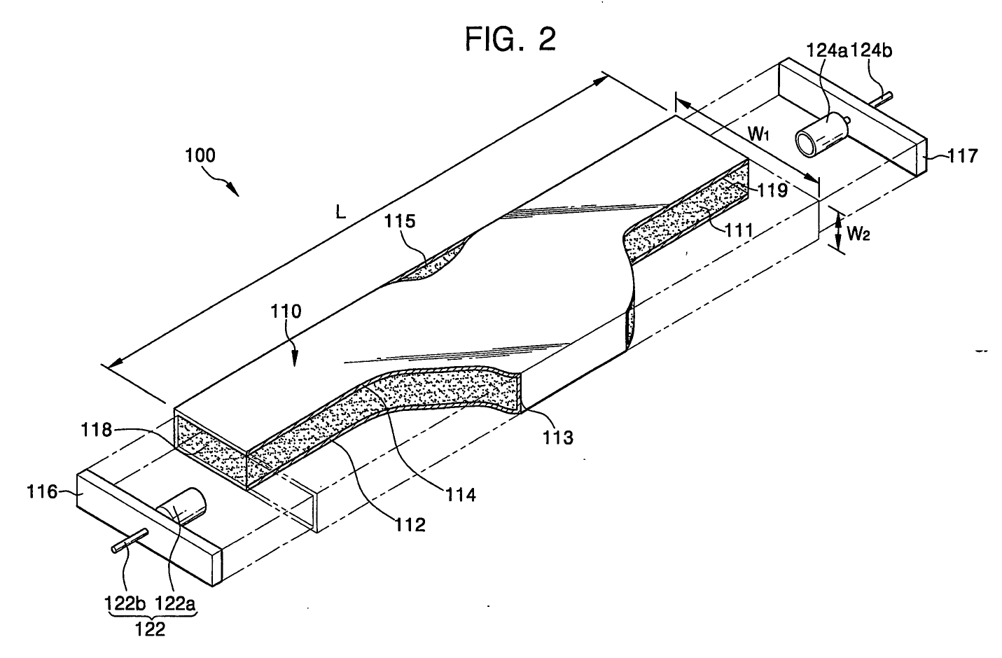

FIG. 2 is a partially cut out perspective view illustrating a lamp according to a first exemplary embodiment of the present invention.

Referring to FIG. 2, a lamp 100 includes a lamp body 110, a first electrode 122 and a second electrode 124.

The lamp body 110 has a rectangular tubular shape. Therefore, the lamp body 110 includes first to fourth sidewalls 112 to 115 connected to each other, a first sealant 116 and a second sealant 117.

The first sidewall 112 is opposite to the second sidewall 114. The first and second sidewalls 112 and 114 have a first length L and a first width W₁. The third sidewall 113 is opposite to the fourth sidewall 115. The third and fourth sidewalls 113 and 115 have the first length L and a second width W₂. Here, the second width W₂ is shorter than the first width W₁. Fluorescent material is coated on inner surfaces of the first to fourth sidewalls 112 to 115.

The lamp body 110 includes a first opening 118 and a second opening 119 opposite to the first opening 118. A discharge gas 111 is injected into the lamp body 110 through the first and second openings 118 and 119.

The first and second sealants 116 and 117 seal the first and second openings 118 and 119 respectively to confine the discharge gas 111.

The first and second electrodes 122 and 124 are disposed at the first and second sealants 116 and 117, respectively.

The first electrode 122 includes a first internal electrode 122a and a first lead wire 122b, and the second electrode 124 includes a second internal electrode 124a and a second lead wire 124b.

The first lead wire 122b comprises a metal, for example, such as nickel (Ni), copper (Cu), etc. The first lead wire 122b is disposed through the first sealant 116 to be electrically connected to the first internal electrode 122a that is disposed inside of the lamp body 110. The first internal electrode 122a that has a circular cylindrical shape to be easily discharged comprises a metal, for example, such as nickel (Ni), copper (Cu), etc.

The second lead wire 124b comprises a metal, for example, such as nickel (Ni), copper (Cu), etc. The second lead wire 124b is disposed through the second sealant 117 to be electrically connected to the second internal electrode 124a that is disposed inside of the lamp body 110. The second internal electrode 124a is disposed opposite to the first internal electrode 122a. The second internal electrode 124a that has a circular cylindrical shape to discharge the discharge gas easily comprises a metal, for example, such as nickel (Ni), copper (Cu), etc.

A power wire may be welded to be electrically connected to the first and second lead wires 122b and 124b. The first and second lead wires 122b and 124b may also be inserted into a clip, to which a power is supplied.

### Embodiment 2

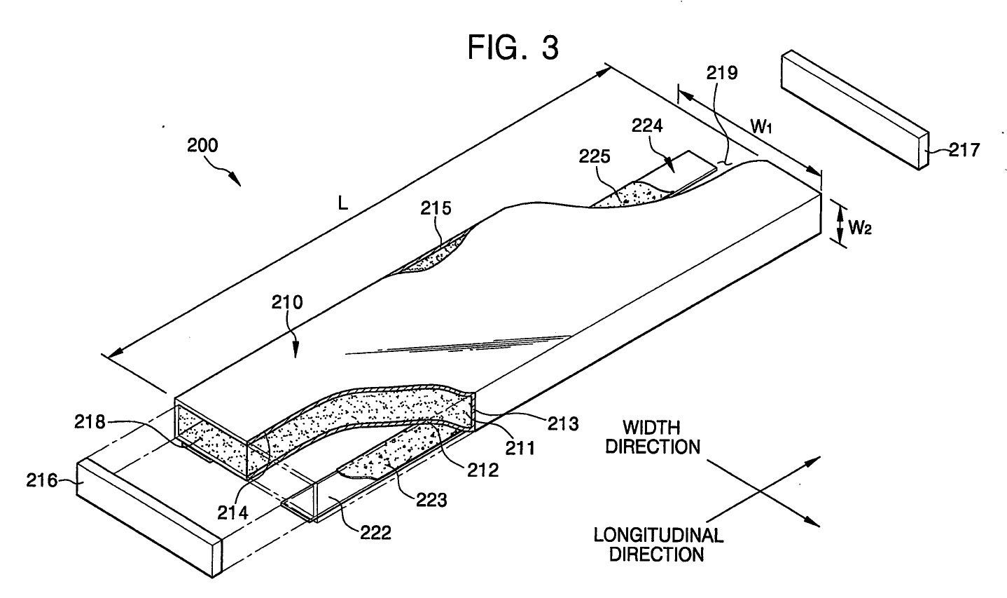

FIG. 3 is a partially cut out perspective view illustrating a lamp according to a second exemplary embodiment of the present invention.

Referring to FIG. 3, a lamp 200 includes a lamp body 210 and first and second electrodes 222 and 224. The lamp body 210 includes first to fourth sidewalls 212 to 215, a first sealant 216 and a second sealant 217.

The first sidewall 212 is opposite to the second sidewall 214. The first and second sidewalls 212 and 214 have a first length L and a first width W₁. The third sidewall 213 is opposite to the fourth sidewall 215. The third and fourth sidewalls 213 and 215 have the first length L and a second width W₂. The second width W₂ is shorter than the first width W₁. Fluorescent material is coated on inner surfaces of the first to fourth sidewalls 212 to 215.

The lamp body 210 includes first and second openings 218 and 219 opposite to each other. A discharge gas 211 is injected into the lamp body 210 through the first and second openings 218 and 219.

The first and second sealants 216 and 217 are disposed in the first and second openings 218 and 219, respectively. The discharge gas 211 is sealed by the first and second sealants 216 and 217.

The first electrode 222 is bonded with the first sidewall 212 by a conductive adhesives 223, and the second electrode 224 is bonded with the first sidewall 212 by a second conductive adhesives 225.

The first and second electrodes 222 and 224 are disposed on an outer surface of the lamp body 210. One of the first and second electrodes 222 and 224 may be disposed inside of the lamp body 210.

The first electrode 222 and second electrode 224 disposed on an outer surface of the lamp body 210 have a band shape.

Preferably, the first and second electrodes 222 and 224 are extended in longitudinal direction with respect to the lamp body 210. The first electrode 222 is substantially parallel with the second electrode 224, and the first and second electrodes 222 and 224 are formed on the first sidewall 212.

The first and second electrodes 222 and 224 include conductive material. The first and second electrodes 222 and 224 may have thin plate shapes.

### Embodiment 3

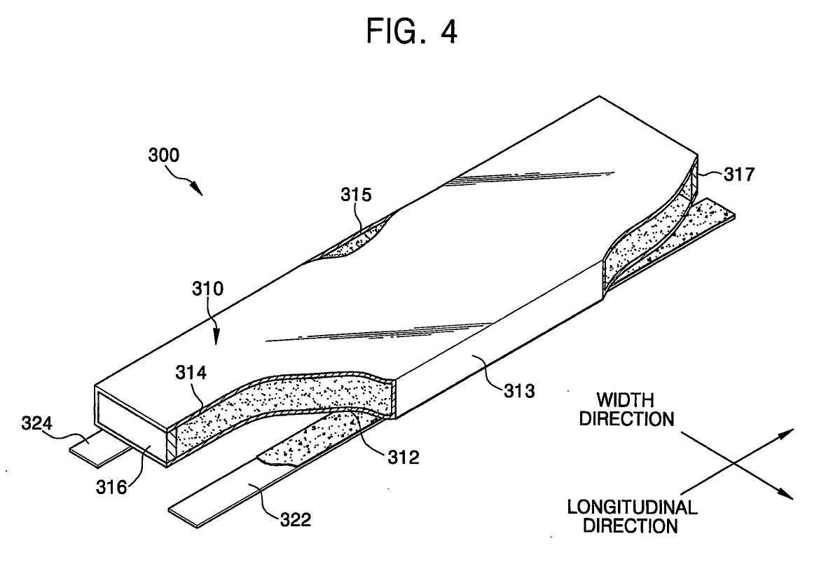

FIG. 4 is a partially cut out perspective view illustrating a lamp according to a third exemplary embodiment of the present invention.

Referring to FIG. 4, a lamp 300 includes a lamp body 310 and first and second electrodes 322 and 324. The lamp of the present embodiment is same as in Embodiment 1 except for first and second electrodes. Thus, the same reference numerals will be used to refer to the same or like parts as those described in Embodiment 1 and any further explanation will be omitted.

First and second electrodes 322 and 324 include conductive material. The first and second electrodes 322 and 324 are disposed on outer surface of the lamp body 310, and have thin plate shapes having a band shape arranged in substantially parallel with each other. The first and second electrodes 322 and 324 are extended in longitudinal direction with respect to the lamp body 310. Portions of the first and second electrodes 322 and 324 are protruded out of the first sealant 316. The protruded portions of the first and second electrodes 322 and 324 are connected to a power supply.

### Embodiment 4

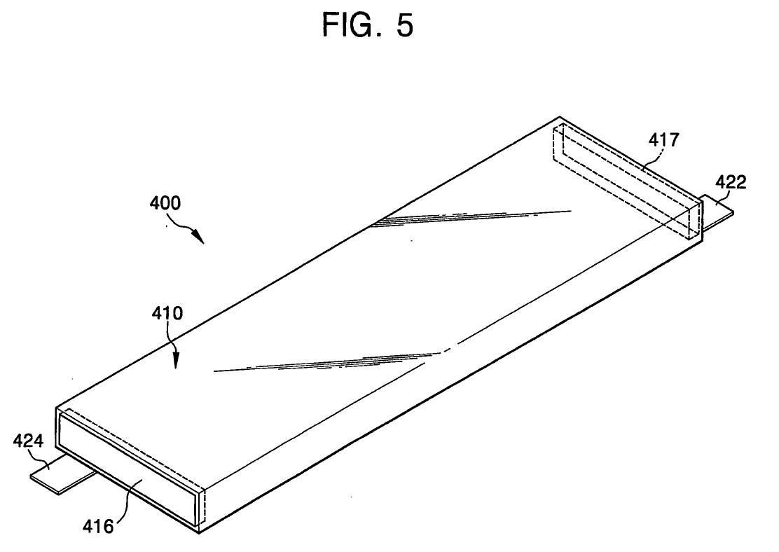

FIG. 5 is a perspective view illustrating a lamp according to a fourth exemplary embodiment of the present invention. The lamp of the present embodiment is same as in Embodiment 1 except for first and second electrodes. Thus, the same reference numerals will be used to refer to the same or like parts as those described in Embodiment 1 and any further explanation will be omitted.

Referring to FIG. 5, a lamp 400 includes a lamp body 410 and first and second electrodes 422 and 424.

The first and second electrodes 422 and 424 include conductive material. The first and second electrodes 422 and 424 having a thin plate shape are disposed on outer surface of the lamp body 410. A portion of the first electrode 422 is extended in longitudinal direction with respect to the lamp body 410, and protruded out of the second sealant 417. A portion of the second electrode 424 is extended in the longitudinal direction with respect to the lamp body 410, and protruded out of the first sealant 416.

### Embodiment 5

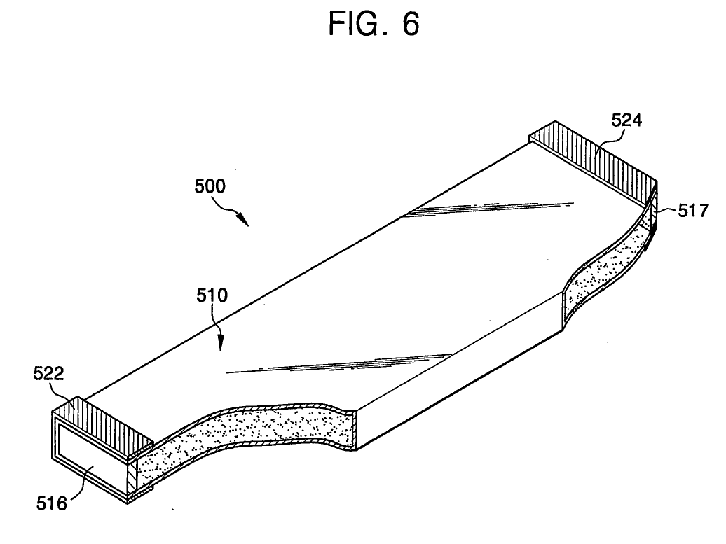

FIG. 6 is a perspective view illustrating a lamp according to a fourth exemplary embodiment of the present invention. The lamp of the present embodiment is same as in Embodiment 1 except for first and second electrodes. Thus, the same reference numerals will be used to refer to the same or like parts as those described in Embodiment 1 and any further explanation will be omitted.

Referring to FIG. 6, a lamp 500 includes a lamp body 510 and first and second electrodes 522 and 524.

The first and second electrodes 522 and 524 may surround each end portion of the lamp body 510 to apart from each other.

Conductive material may be plated on outer surface of the lamp body 510 to form the first and second electrodes 522 and 524. Thin conductive plates may also be disposed on the outer surface of the lamp body 510 to form the first and second electrodes 522 and 524. Liquid transparent conductive material may also be coated on the outer surface of the lamp body 510 and the liquid transparent conductive material may be hardened to form the first and second electrodes 522 and 524. The first and second electrodes 522 and 524 may comprise indium tin oxide, indium zinc oxide, etc.

### Embodiment 6

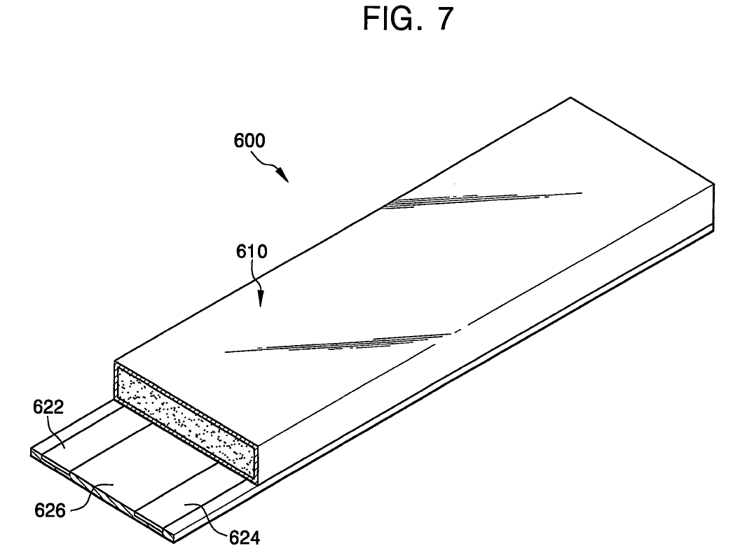

FIG. 7 is a partially cut out perspective view illustrating a lamp according to a sixth exemplary embodiment of the present invention. The lamp of the present embodiment is same as in Embodiment 1 except for first and second electrodes. Thus, the same reference numerals will be used to refer to the same or like parts as those described in Embodiment 1 and any further explanation will be omitted.

Referring to FIG. 7, a lamp 600 includes a lamp body 610, and first and second electrodes 622 and 624. The first and second electrodes 622 and 624 are formed on outer surface of the lamp body 610. The first and second electrodes 622 and 624 are substantially parallel with each other.

An insulating member 626 electrically insulates the first and second electrodes 622 and 624 from other conductors because a high voltage of a range from about 1 kV to about 100 kV is applied to the first and second electrodes 622 and 624. The insulating member 626 covers the first and second electrodes 622 and 624, to which the high voltage is applied, so as to insulate the first and second electrodes 622 and 624. The insulating member 626 has a sufficient thickness and resistance to prevent a dielectric breakdown.

### EMBODIMENTS OF BACKLIGHT ASSEMBLY

### Embodiment 1

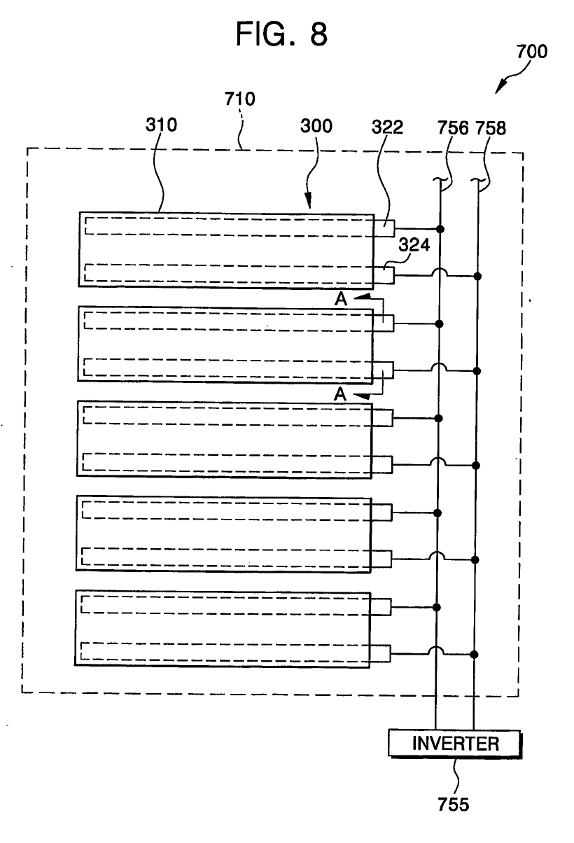

FIG. 8 is a schematic plan view illustrating a backlight assembly according to an exemplary embodiment of the present invention, and FIG. 9 is an exploded perspective view illustrating a backlight assembly according to a first exemplary embodiment of the present invention.

Referring to FIGS. 4, 8 and 9, the backlight assembly 700 includes a receiving container 710, a lamp 300, a first conducting part 756 and a second conducting part 758.

The receiving container 710 includes a bottom plate 701 and a plurality of sidewalls 703. The bottom plate 701 has a quadrangular plate shape. Therefore, the bottom plate 701 includes four sides, and the sidewalls 703 are extended from the sides of the bottom plate to form a receiving space. The receiving container 710 may comprise metal to prevent the receiving container 710 from being deformed by an external force.

A lamp 300 is disposed on the bottom plate 701 of the receiving container 710. A plurality of the lamps 300 may be disposed on the bottom plate 701 of the receiving container 710. The lamp 300 includes a lamp body 310 and first and second electrodes 322 and 324.

The lamp body 310 has a tubular shape of which cross-section having major and minor axes. A discharge gas is injected into the lamp body 310, and fluorescent material is coated on inner surfaces of the lamp body 310.

The lamp body 310 has a rectangular parallelepiped shape. The lamp body 310 includes first to fourth sidewalls 312 to 315, a first sealant 316 and a second sealant 317. Here, the first sidewall 312 is corresponding to the bottom plate 701 of the receiving container 710, and the second sidewall 314 is opposite to the first sidewall 312.

The first and second electrodes 322 and 324 may be disposed on the first sidewall 312. The first and second electrodes 322 and 324 include conductive material, and the first and second electrodes 322 and 324 are arranged at end portions of the lamp body 310. The first and second electrodes 322 and 324 are extended in longitudinal direction with respect to the lamp body 310. The first electrode 322 is disposed substantially parallel with the second electrode 324 to prevent the first and second electrodes 322 and 324 from electrical short.

End portions of the first and second electrodes 322 and 324 are protruded from the lamp body 310.

Referring to FIG. 8, the first electrode 322 is electrically connected to a first conducting part 756 through which a first discharge voltage is applied to the first electrode 322. The second electrode 324 is electrically connected to a second connecting part 758 through which a second discharge voltage is applied to the second electrode 324.

When a plurality of lamps 300 is disposed in the receiving container 710, the first and second electrodes 322 and 324 of each of the lamps 300 are connected to the first and second conducting parts 756 and 758 substantially in parallel.

Different voltages are applied to the first and second conducting parts 756 and 758 so that the first and second conducting parts 756 and 758 are insulated from each other.

An inverter 755 applies a first and second discharge voltages to the first and second conducting parts 756 and 758.

A high voltage of a range from about 1 kV to about 100 kV is applied to the first and second electrodes 322 and 324 via the first and second conducting parts 756 and 758. The receiving container 710 may have metal. Therefore, when the receiving container 710 is electrically shorted to the first electrode 322, the second electrode 324, the first conducting part 756 or the second conducting part 758, the backlight assembly may be damaged and dangerous to humans.

The receiving container 710 is electrically insulated from the lamp 300, the first conducting part 756 and the second conducting part 758 to prevent the short.

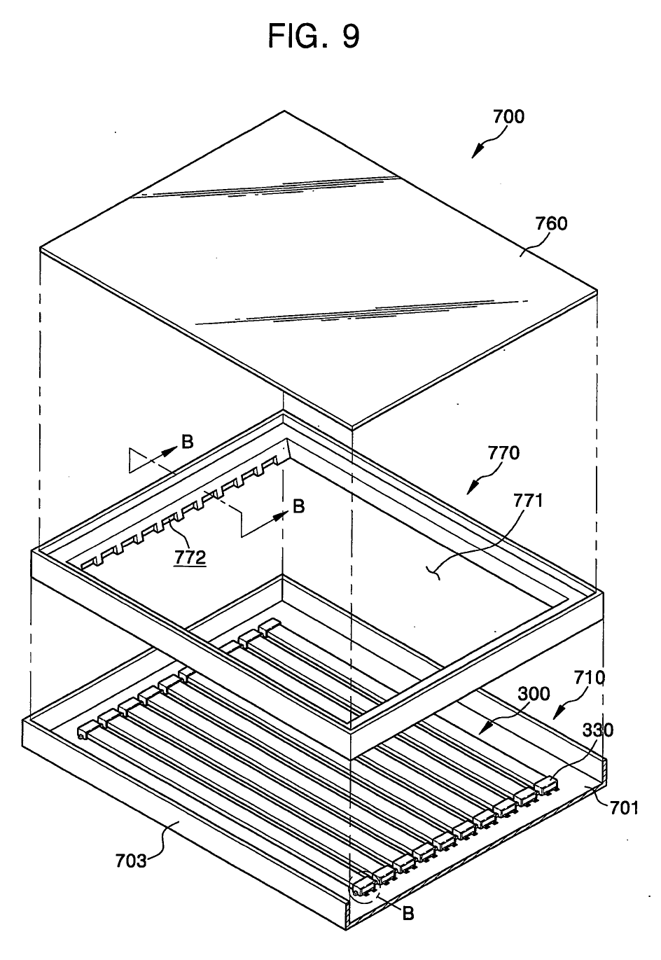

FIG. 10 is a cross-sectional view taken along a line A-A′ of FIG. 8. Referring to FIG. 10, an insulating member 751 is formed on a bottom plate opposite to the lamp 300, the first conducting part 756 and the second conducting part 758 of the receiving container 710. The insulating member 751 has a sufficient thickness and a resistance to prevent a dielectric breakdown. The insulating member 751 may correspond to an insulating layer.

Referring again to FIG. 9, the lamp 300 comprises glass that is fragile. A lamp holder 330 is formed to protect the lamp 300. A plurality of the lamp holders 330 may be disposed on the bottom plate 701.

The lamp holders 330 are disposed on end portions of the lamp 300 so as to receive the lamp 300. The lamp 300 is inserted into the lamp holder 330. The lamp holder 330 comprises elastic material, for example, such as rubber, plastics, etc., to prevent the lamp 300 from being damaged. The lamp holder 330 absorbs impact, and electrically insulates the receiving container 710 from the first and second electrodes 322 and 324.

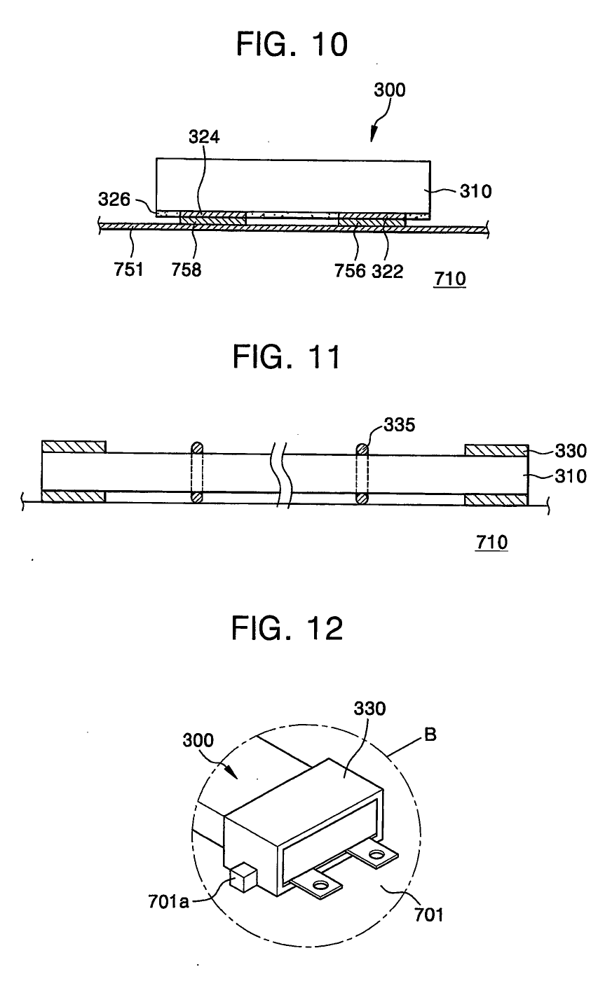

FIG. 11 is a side view illustrating a lamp supporting member according to the first exemplary embodiment of the present invention.

Referring to FIG. 11, as the lamp 300 becomes longer, the lamp 300 becomes heavier. Thus, the lamp 300 may sag due to the lamp's own weight, so that a central portion of the lamp 300 may make contact with the bottom plate 701 of the receiving container 300.

A lamp supporting member 335 may be disposed between the lamp holders 330 to prevent the lamp 300 from sagging. The lamp supporting part 335 includes the elastic material.

FIG. 12 is an enlarged perspective view illustrating a portion “B” of FIG. 9.

Referring to FIG. 12, a lamp fixing protrusion 701a is formed in the receiving container 710 where the lamp 300 is disposed to fix the lamp 300 disposed on the bottom plate of the receiving container 710. A portion of the receiving container 710 is removed to form recesses (not shown) corresponding to the lamp securing projection 701a so that the lamp securing projection 701a is fixed with the recesses.

A portion of the bottom plate may be recessed upward to form the lamp fixing protrusion 701a, or the portion of the bottom plate may be protruded upward to form the lamp fixing protrusion 701a. A separate piece may be inserted into a hole formed on the bottom plate to form the lamp fixing protrusion 701a.

A pair of lamp fixing protrusions 701a is spaced apart from each other by a width of the lamp holder 330 so that the lamp holder 330 is inserted between the lamp fixing protrusions 701a. Therefore, the lamp 300 is fixed to the receiving container 710.

Referring again to FIG. 9, the backlight assembly 700 may include a light diffusion plate 760. The light diffusion plate 760 is disposed on the lamp 300 to uniformize luminance of a light generated from the lamp 300.

A receiving block 770 may be formed to fix the light diffusion plate 760 to the receiving container 710.

The receiving block 770 is disposed on the bottom plate 701 along the inner surfaces of the sidewall 703 of the receiving container 710. The receiving block 770 has a quadrangular frame shape having an opening 771 at a central portion of the receiving block 770. A portion of the receiving block 770 is overlapped with the lamp holder 330, and a lamp receiving recess 772 is formed at the overlapped portion. The lamp receiving recess 772 receives the lamp holder 330 to prevent the lamp 300 from drifting.

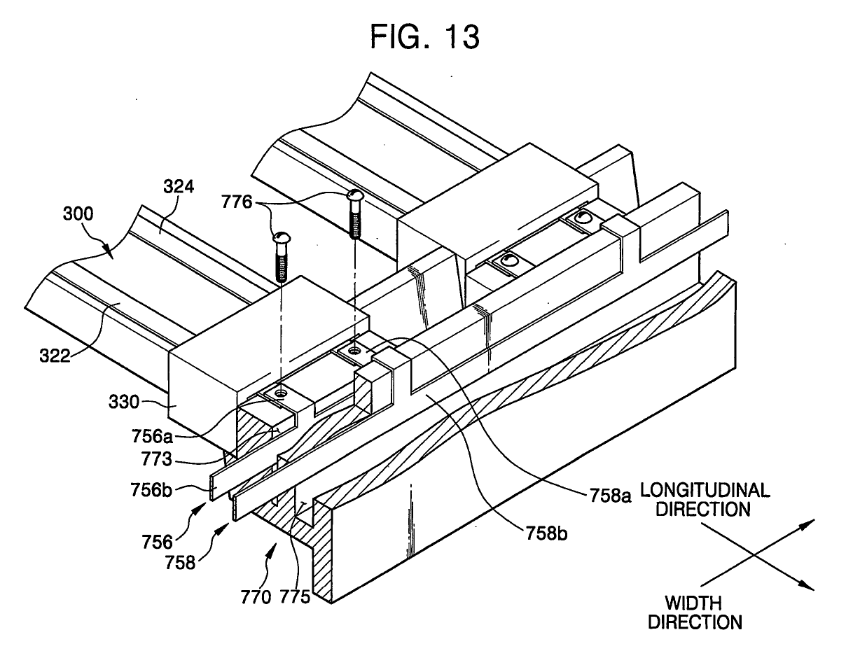

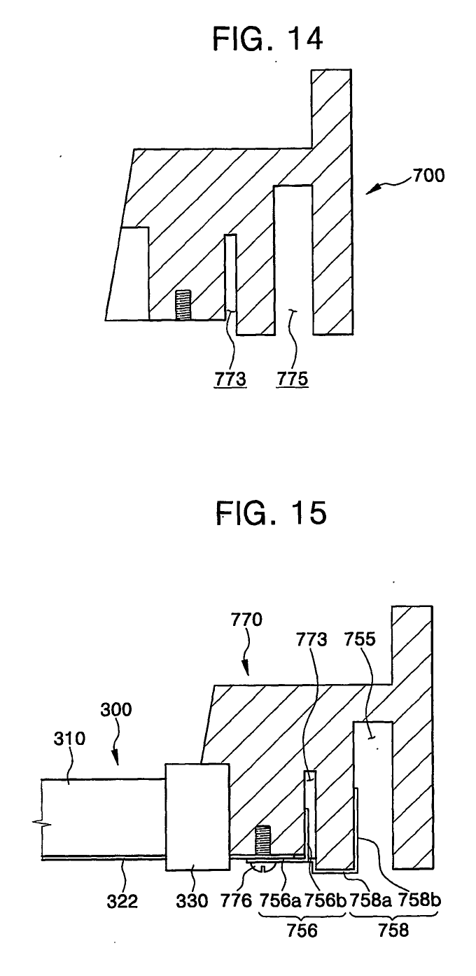

FIG. 13 is an exploded perspective view illustrating a lamp inserted into a receiving block according to an exemplary embodiment of the present invention, and FIG. 14 is a cross-sectional view taken along a line B-B′ of FIG. 9.

Referring to FIGS. 13 and 14, the receiving block 770 includes first and second slots 773 and 775. The first and second slots 773 and 775 are extended in a width direction that is substantially perpendicular to the longitudinal direction of the lamp 300, such that the first and second slots 773 and 775 are spaced apart from each other.

FIG. 15 is a cross-sectional view illustrating first and second conducting parts inserted into first and second slots according to an exemplary embodiment of the present invention, respectively.

Referring to FIGS. 13 and 15, the first conducting part 756 includes a first connecting electrode 756a and a first common electrode 756b. The first conducting part 756 may include a plurality of the first connecting electrodes 756a. Each of the first connecting electrodes 756a is electrically connected to each of the first electrodes 322, and the first common electrode 756b is connected to all of the first connecting electrodes 756a.

The first common electrode 756b is disposed in the first slot 773, and the first connecting electrodes 756a are folded toward the first electrodes 322, such that the first electrodes 322 and the first connecting electrode 756a are overlapped with each other. The overlapped portions of the first connecting electrode 756a and first electrodes 322 are combined by screws.

The second conducting part 758 includes a second connecting electrode 758a and a second common electrode 758b. The second conducting part 758 may include a plurality of the second connecting electrodes 758a. The second connecting electrodes 758a are electrically connected to each of the second electrodes 324, and the second common electrode 758b is connected to all of the second connecting electrodes 758a.

The second common electrode 758b is disposed in the second slot 775, and the second connecting electrodes 758a are folded toward the second electrodes 324, such that the second electrodes 324 are overlapped with the second connecting electrodes 758a. The overlapped portions of the second connecting electrode 758a and the second electrodes 324 are combined with each other by screws.

The first common electrodes 756b is electrically connected to the inverter 755, so that a first discharge voltage generated from the inverter 755 may be applied to the first electrode 322 via the first common electrodes 756b and first connecting electrode 756a. Likewise, the second common electrode 758b is electrically connected to the inverter 755, so that a second discharge voltage generated from the inverter 755 may be applied to the second electrode 324 via the second common electrode 758b and second connecting electrode 758a.

Hereinafter, a procedure of assembling the first and second conducting parts 756 and 758 will be explained.

Referring to FIG. 13, the receiving block 770 is disposed upside down. The common electrode 756b of the first conducting part 756 is then inserted into the first blot 773. Therefore, the first connecting electrodes 756a are disposed on the bottom plate of the receiving block 770, and overlapped with the first electrodes 322. The first electrodes 322 are then fixed to the first connecting electrodes 756a by the screws 776.

The second common electrode 758b of the second conducting part 758 is then inserted into the second slot 775. Therefore, the second connecting electrodes 758b are disposed on the bottom plate of the receiving block 770. The second connecting electrodes 758b are substantially parallel with the first connecting electrodes 756a. The second connecting electrodes 758a are overlapped with the second electrodes 324. The second electrodes 324 are then fixed to the second connecting electrodes 758a by the screws.

The receiving block 770 in which the lamp 300 is fixed is then disposed on the bottom plate 701 of the receiving container 710.

### Embodiment 2

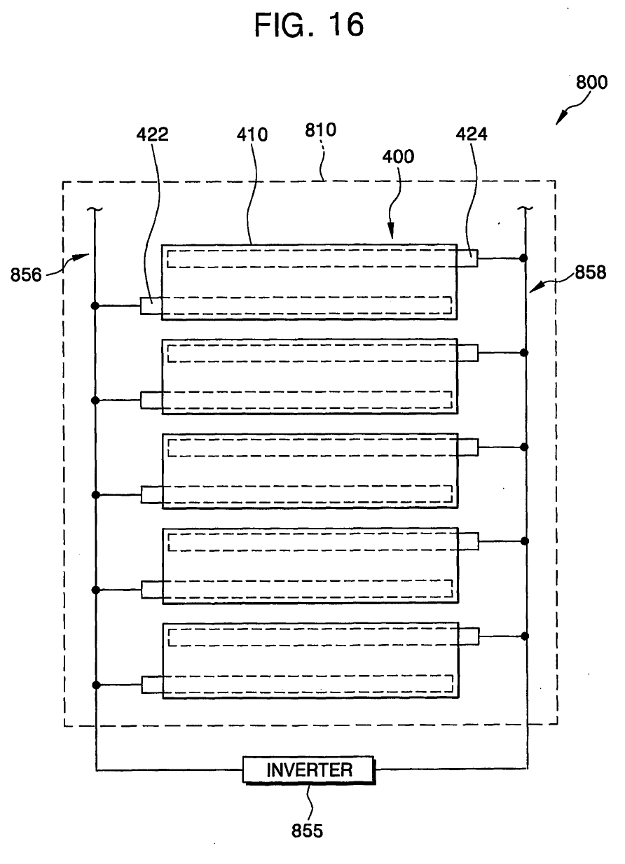

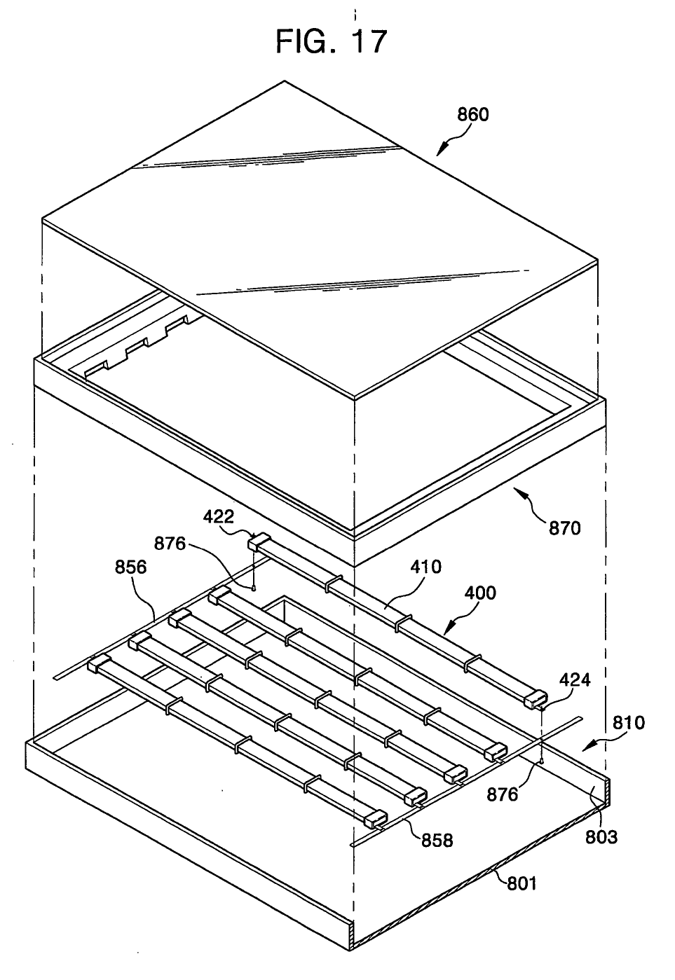

FIG. 16 is a plan view illustrating a backlight assembly according to a second exemplary embodiment of the present invention, and FIG. 17 is an exploded perspective view illustrating the backlight assembly of FIG. 16.

Referring to FIGS. 16 and 17, a backlight assembly 800 includes a receiving container 810, a lamp 400, a first conducting part 856 and a second conducting part 858. The first and second conducting parts 856 and 858 are connected to an inverter 855. The backlight assembly 800 may include a plurality of the lamps 400.

The receiving container 810 includes a bottom plate 801 and a sidewall 803. The receiving container 810 may include a plurality of the sidewalls 803. Preferably, the bottom plate 801 has a quadrangular plate shape. The sidewalls 803 are extended from sides of the bottom plate 801 to form a receiving space.

The first conducting part 856 is disposed on a first end portion of the lamp 400, and the second conducting part 858 is disposed on a second end portion of the lamp 400.

The lamp 400 includes a lamp body 410 and first and second electrodes 422 and 424. The lamp body 410 is substantially perpendicular to the first and second conducting parts 856 and 858.

The first and second electrodes 422 and 424 have a band shape. The first electrode 422 is substantially parallel with the second electrode 424 to prevent the first and second electrodes 422 and 424 from electrical short.

An end portion of the first electrode 422 is protruded out of the lamp body 410 to be overlapped with the first conducting part 856, thereby being secured with the first conducting part 856 by means of a screw 876. An end portion of the second electrode 424 is protruded out of the lamp body 410 to be overlapped with the second conducting part 858, thereby being secured with the second conducting part 858 by means of the screw 876.

The receiving container 810 is insulated from the first conducting part 856, the second conducting part 858, the first electrodes 422 of the lamps 400 and the second electrodes 424 of the lamps 400.

A receiving block 870 may be disposed in the receiving container 810 to secure the lamps 400 and to receive a light diffusion plate 860.

The receiving block 870 has a quadrangular frame shape having an opening in the receiving block 870. The first and second conducting parts 856 and 858 are disposed on a bottom plate of the receiving block 870. The first and second conducting parts 856 and 858 are substantially parallel with each other and have the opening between the first and second conducting parts 856 and 858.

### Embodiment 3

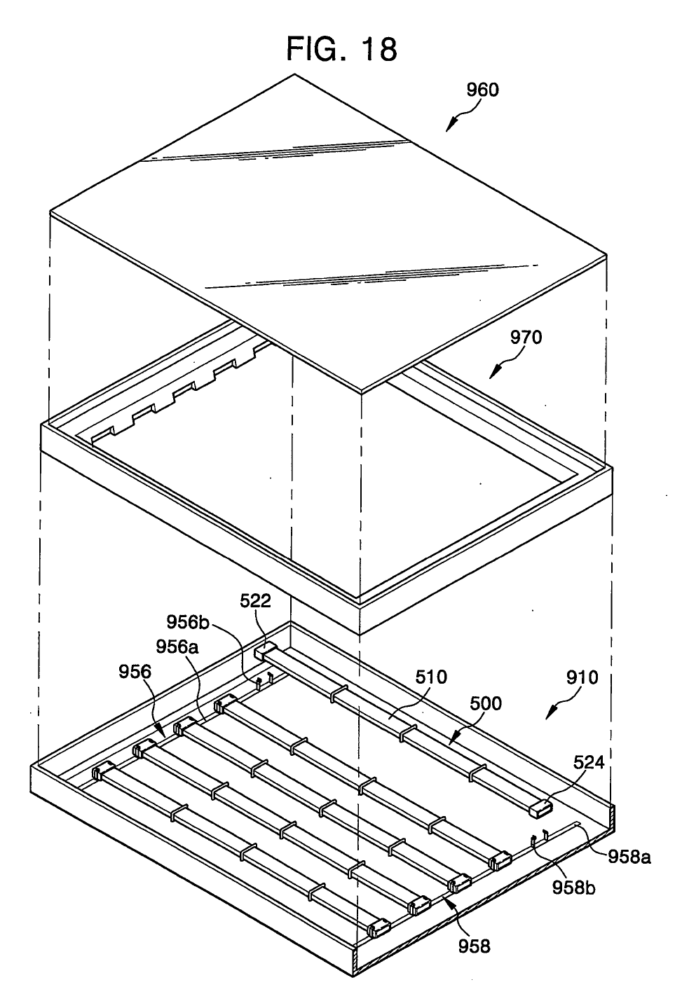

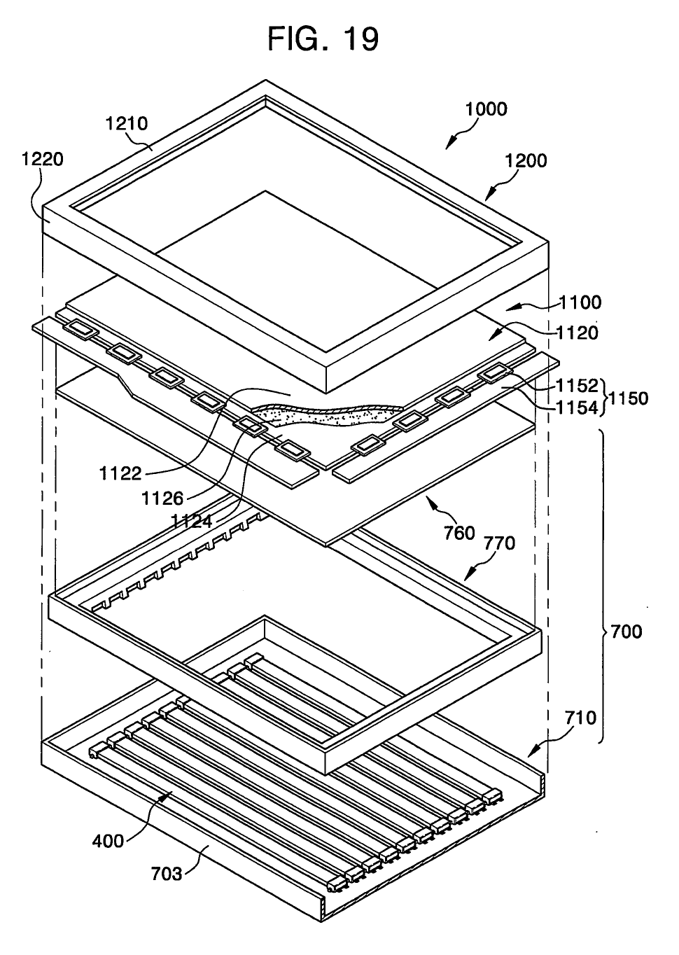

FIG. 18 is an exploded perspective view illustrating a backlight assembly according to a third exemplary embodiment of the present invention.

Referring to FIGS. 4 and 18, a backlight assembly 900 includes a receiving container 910, a lamp 500, a first conducting part 956 and a second conducting part 958. The backlight assembly 900 may include a plurality of the lamps 500. Referring now in specific detail to FIG. 18 in which the elements of the receiving container 910 denote the same elements of the receiving container 710 in FIG. 8, and thus any further detailed descriptions concerning the same elements of the receiving container 910 will be omitted.

The lamp 500 includes a lamp body 510 and electrodes 522 and 524. The electrodes 522 and 524 are disposed on end portions of the lamp body 510, and the electrodes 522 and 524 surround the lamp body 510 in width direction.

Conductive material may be plated on outer surface of the lamp body 510 to form the first and second electrodes 522 and 524. Thin conductive plates may also be disposed on the outer surface of the lamp body 510 to form the first and second electrodes 522 and 524. Liquid transparent conductive material may also be coated on the outer surface of the lamp body 510 and the liquid transparent conductive material may be hardened to form the first and second electrodes 522 and 524. The first and second electrodes 522 and 524 may comprise indium tin oxide, indium zinc oxide, etc.

The first conducting part 956 includes a first common electrode 956a and a first clip 956b. The first conducting part 956 may include a plurality of the first clips 956b. The first clip 956b is connected to the first common electrode 956a, and thus number of the first clips 956b is equal to number of the lamps 500.

The second conducting part 958 includes a second common electrode 958a and a second clip 958b. The second conducting part 958 may include a plurality of the second clips 958b. Since the second clip 958b is connected to the second common electrode 958a, number of the second clips 958b is equal to the number of the lamps 500.

The first and second electrodes 522 and 524 of each of the lamps 500 are connected to the first and second clips 856b and 858b.

An inverter applies first and second discharge voltages to the first and second conducting parts 956 and 958, respectively.

The receiving block 970 is disposed on the backlight assembly 900. The receiving block 970 includes a quadrangular frame shape having an opening. The opening is disposed in a center of the receiving block 970.

A light diffusion plate 960 is disposed on the receiving block 970 of the backlight assembly 900.

When a cross-section of the lamp 500 has a circular shape, the distance between the light diffusion plate 960 and lamp 500 is increased. However, when a cross-section of the lamp 500 has a quadrangular shape, the distance between the light diffusion plate 960 and lamp 500 may be reduced.

The distance between the light diffusion plate 960 and lamp 500 is decreased by the lamp 500. Therefore, volume of the backlight assembly 900 is decreased so that volume of the LCD apparatus is decreased.

When the lamp 500 has circular shape, amount of a light substantially perpendicular to the light diffusion plate 960 is decreased so that luminance of the light is decreased. However, when the lamp 500 has substantially flat shape, amount of a light substantially perpendicular to the light diffusion plate 960 is increased so that luminance of the light is increased. Therefore, luminance of the LCD apparatus is increased by the lamp 500 according to the exemplary embodiment of the present invention.

In addition, amount of current applied to the lamp is decreased to decrease power consumption while the luminance is increased.

FIG. 19 is an exploded perspective view illustrating an LCD apparatus according to an exemplary embodiment of the present invention.

Referring to FIG. 19, the LCD apparatus includes a backlight assembly 700, an LCD panel assembly 100 and a chassis 1200.

Referring now in specific detail to FIG. 19 in which the elements of the backlight assembly 700 denote the same elements of the backlight assembly in FIG. 8, and thus any further detailed descriptions concerning the same elements of the backlight assembly 700 will be omitted.

The LCD panel assembly 1100 is disposed on a light diffusion plate 760 disposed on a receiving block 770 of the backlight assembly 700.

The LCD panel assembly 1100 converts a light supplied from the backlight assembly 700 into an image light having information. The LCD panel assembly 1100 includes an LCD panel 1120 and a driving module 1150.

The LCD panel 1120 includes a TFT substrate 1124, a liquid crystal 1126 and a color filter substrate 1222. The driving module 1150 is disposed on the TFT substrate 1124. The driving module 1150 may be formed integrally with the TFT substrate 1124.

The driving module 1150 includes a printed circuit board (PCB) 1154 and a flexible circuit board (FCB) 1152. The PCB 1154 converts an externally provided visual signal into an image signal to apply to the LCD apparatus. The FCB 1152 applies the image signal generated from the PCB 1154 to the TFT substrate 1124 in accordance with a predetermined timing.

The LCD panel 1120 disposed on the backlight assembly 700 is secured in a horizontal direction with respect to the LCD apparatus, but the LCD panel 1120 is movable in a vertical direction with respect to the LCD apparatus. Since the LCD panel 1120 comprises a glass substrate, the LCD panel 1120 is fragile.

The chassis 1200 secures the LCD panel 1120 with the backlight assembly 700 to prevent the LCD panel assembly 1100 from being damaged or drifting.

The chassis 1200 includes a pushing surface 1210 surrounding sides of the LCD panel assembly 1100 and a securing surface 1220 securing the pushing surface 1210 with the backlight assembly 700.

The pushing surface 1210 has a quadrangular frame shape that pushes the LCD panel assembly 1100, and the securing surface 1220 is extended from outer surface of the pushing surface 1210 into sidewalls 703 of the receiving container 710 of the backlight assembly 700.

The securing surface 1220 is hooked to the sidewall 703 of the receiving container 710 to form the LCD apparatus.

### INDUSTRIAL APPLICABILITY

As mentioned above, a shape of a lamp is changed so that luminance of a light generated from the lamp is increased and uniformized to increase quality of an image generated from the LCD apparatus.

Also, the luminance of the lamp is increased to decrease power consumption of the lamp.

In addition, the lamp has substantially flat shape to decrease volume of a backlight assembly or the LCD apparatus.

Furthermore, the lamp, the backlight assembly and the LCD apparatus have uniform optical distribution so that an optical sheet may be omitted. The light generated from the light is substantially perpendicular to the LCD panel so that a prism sheet that is expensive may be omitted. Therefore, number of components of the backlight assembly and the LCD apparatus may be decreased, and manufacturing cost of the backlight assembly and the LCD apparatus may also be decreased.

Although the exemplary embodiments of the present invention have been described, it is understood that the present invention should not be limited to these exemplary embodiments but various changes and modifications can be made by one ordinary skilled in the art within the scope of the present invention as hereinafter claimed.

1. A lamp comprising:
a lamp body having a tubular shape, a cross-section of the lamp body including a major axis and a minor axis, the major axis substantially in parallel with a light incident surface of an LCD panel; and
a plurality of electrodes applying discharge voltage to the lamp body.

2. The lamp of claim 1, wherein the lamp body has an elliptical cylinder shape, a rectangular tubular shape or a tubular shape having a convex surface opposite to the light incident surface.

3. The lamp of claim 1, wherein the electrodes comprise a first internal electrode disposed in the lamp body, and a second electrode disposed opposite to the first internal electrode,
the first and second internal electrodes include a first and second lead wires respectively, and a portion of each of the lead wires is protruded out of the lamp body.

4. The lamp of claim 1, wherein at least one of the electrodes is disposed on outer surface of the lamb body.

5. The lamp of claim 1, wherein the electrodes comprise conductive plate shapes having a band shape arranged substantially in parallel with each other in a longitudinal direction relative to the lamp body, and the electrodes are spaced apart from each other.

6. The lamp of claim 1, wherein the electrodes comprise plated metal layers having a band shape arranged in substantially parallel with each other in a longitudinal direction relative to the lamp body, and the electrodes are spaced apart from each other.

7. The lamp of claim 1, wherein the electrodes surrounding a portion of outer surface of the lamp body comprise conductive plate shapes having a band shape arranged substantially in parallel with each other, and are spaced apart from each other.

8. The lamp of claim 1, wherein the electrodes surrounding a portion of outer surface of the lamp body comprise plated metal layers having a band shape arranged substantially in parallel with each other, and are spaced apart from each other.

9. The lamp of claim 1, wherein the electrodes that are spaced apart from each other have a band shape arranged substantially in parallel with each other in longitudinal direction relative to the lamp body,
and a portion of each of the electrodes is protruded out of the lamp body in a predetermined direction.

10. The lamp of claim 1, wherein the electrodes that are spaced apart from each other comprise a pair of electrodes having a band shape arranged substantially in parallel with each other in longitudinal direction relative to the lamp body,
and portions of the electrodes are protruded out of the lamp body in opposite directions.

11. The lamp of claim 1, wherein the electrodes are electrically insulated from each other by an insulating member.

12. A backlight assembly comprising:
a receiving container including a bottom plate and a plurality of sidewalls protruded from a side of the bottom plate to define a receiving space;
a plurality of lamps including a lamp body that has a tubular shape and a plurality of electrodes including first and second electrodes, a cross-section of the lamp body including a major axis substantially parallel with the light incident surface and a minor axis;
a first conducting part applying a first discharge voltage to the first electrode through a first path; and
a second conducting part applying a second discharge voltage to the second electrode through a second path.

13. The backlight assembly of claim 12, further comprising an insulating member protecting the first and second electrodes.

14. The backlight assembly of claim 12, further comprising a plurality of lamp holders surrounding end portions of the lamp to absorb impact that is provided from an exterior to the lamp.

15. The backlight assembly of claim 12, further comprising at least one lamp supporting member that prevents the sagging of the lamp.

16. The backlight assembly of claim 12, wherein the receiving container further includes a pair of lamp fixing protrusions formed on the bottom plate so that the lamp is inserted into between the lamp fixing protrusions.

17. The backlight assembly of claim 12, wherein the receiving container further includes a receiving block disposed along inner surfaces of the sidewalls of the receiving container, and the receiving block supports a light diffusion plate with the receiving block.

18. The backlight assembly of claim 17, wherein the receiving container includes a first slot spaced apart from the end portion of the lamp by a first distance, a second slot spaced apart from the end portion of the lamp by a second distance greater than the first distance, and the first and second slots are disposed in a bottom plate of the receiving block.

19. The backlight assembly of claim 18, wherein the first and second electrodes having a band shape arranged substantially in parallel with each other are formed on outer surface of the lamp body, and
portions of the first and second electrodes are protruded out of the lamp body into the first and second slots, respectively.

20. The backlight assembly of claim 19, wherein the first and second conducting parts include first and second common electrodes disposed in the first and second slots, and first and second connecting electrodes extended from the first and second common electrodes to be connected to the first and second electrodes, respectively.

21. The backlight assembly of claim 12, wherein the first electrode is protruded out of the lamp in a first direction along the longitudinal direction relative to the lamp, and
the second electrode is protruded out of the lamp in a second direction opposite to the first direction along the longitudinal direction relative to the lamp.

22. The backlight assembly of claim 21, wherein the receiving container further comprises a receiving block disposed along inner surfaces of the sidewalls of the receiving container,
and wherein the first and second conducting parts are disposed on the bottom plate of the receiving block.

23. The backlight assembly of claim 12, wherein the first and second electrodes surround end portions of the lamp body.

24. The backlight assembly of claim 23, wherein the first and second conducting parts comprise first and second clips connected to the first and second electrodes.

25. An LCD apparatus comprising:
a receiving container including a bottom plate and a plurality of sidewalls protruded from a side of the bottom plate to define a receiving space;
a plurality of lamps including a lamp body having a tubular shape and a plurality of electrodes having first and second electrodes disposed on the lamp body, a cross-section of the lamp body including a major axis substantially parallel with the light incident surface and a minor axis;
a first conducting part applying a first discharge voltage to the first electrode through a first path;
a second conducting part applying a second discharge voltage to the second electrode through a second path;
an LCD panel disposed on the receiving block; and
a chassis secured with the receiving container to prevent the LCD panel from drifting.

26. The LCD apparatus of claim 25, wherein the lamp body has a rectangular shape,
the first and second electrodes have a band shape arranged substantially in parallel with each other, the electrodes formed on outer surface of the lamp body, and
portions of the first and second electrodes are protruded out of the lamp body to be connected to the first and second conducting parts, respectively.

27. The LCD apparatus of claim 25, wherein the first conducting part comprises a plurality of first connecting electrodes connected to the first electrode and a first common electrode connected to the first connecting electrodes, the first common electrode secured with the receiving block, and
the second conducting part comprises a plurality of second connecting electrodes connected to the second electrode and a second common electrode connected to the second connecting electrodes, the second common electrode spaced apart from the first conducting part to be secured with the receiving block.
